(19) United States
(12) Patent Application Publication
(10) Pub. No.: US 2008/0238005 A1
(43) Pub. Date: Oct. 2, 2008

(54) Tilting Vehicle

(76) Inventor: Phillip Ronald James, Kilburn North (AU)

Correspondence Address: PHILLIP R. JAMES, P.O. BOX 1060, KILBUM NORTH, 5084, AU

(21) Appl. No.: 10/586,819

(22) PCT Filed: Feb. 2, 2005
(86) PCT No.: PCT/AU05/00110

§ 371 Date: Jul. 20, 2006

(30) Foreign Application Priority Data
Feb. 6, 2004 (AU) 2004900556
Sep. 30, 2004 (AU) 2004905617

(51) Int. Cl. B62D 9/02

(52) U.S. Cl. 280/5.509

(57) ABSTRACT

A tilting vehicle comprising at least one section (17) tiltable about the longitudinal axis of the vehicle, tilt registration means (20) recording variations in the tilt position of the tiltable section (17), a control element (5), tilt control means (12) connecting the control element (5) to the tilt section (17), at least three wheels (42, 42a, 45) including wheels (42, 42a) laterally spaced, a castoring element including at least one front wheel (42, 42a) able to tilt with the tiltable section (17) and dynamically directionally controllable due to the tilt and speed of the vehicle, a speed sensitive control signal transmitter (21), a variable force steer transmitter (16) connected to the castoring element, the tilt registration means (20) and to the speed sensitive control signal transmitter (21), the variable force steer transmitter (16) being able to exert a directing moment and/or positioning moment on the castoring element, that directs and/or positions the castoring element according to the tilt registration means (20) and the force exerted by the variable force steer transmitter (16), which is varied by control signals from the speed sensitive control signal transmitter (21).

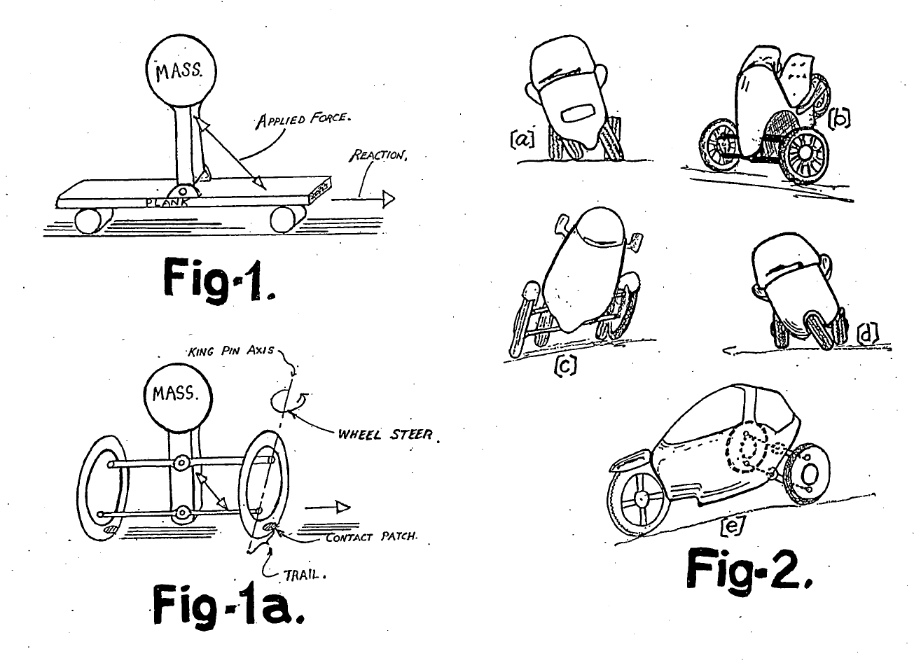

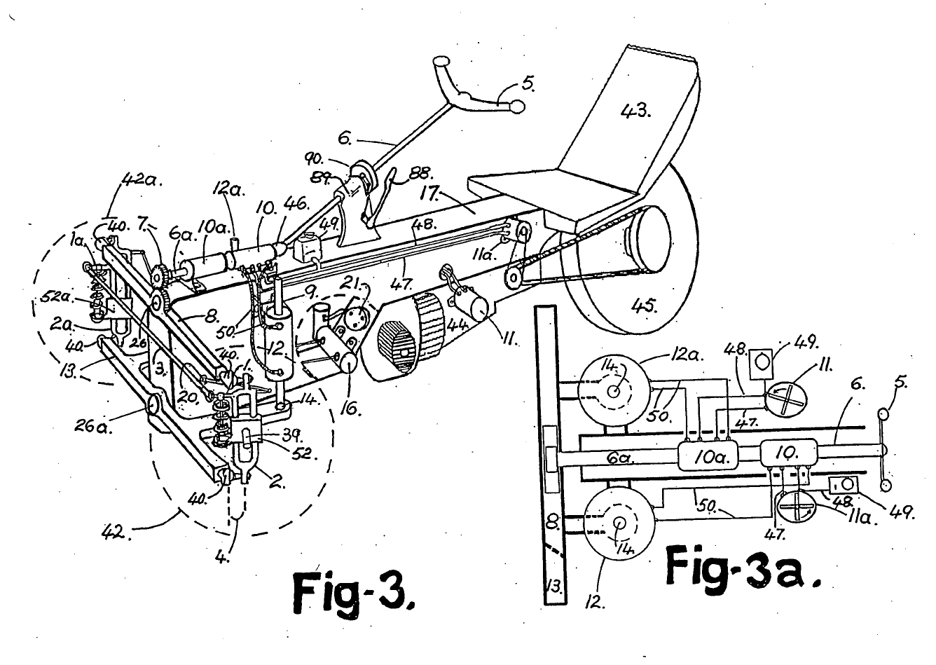

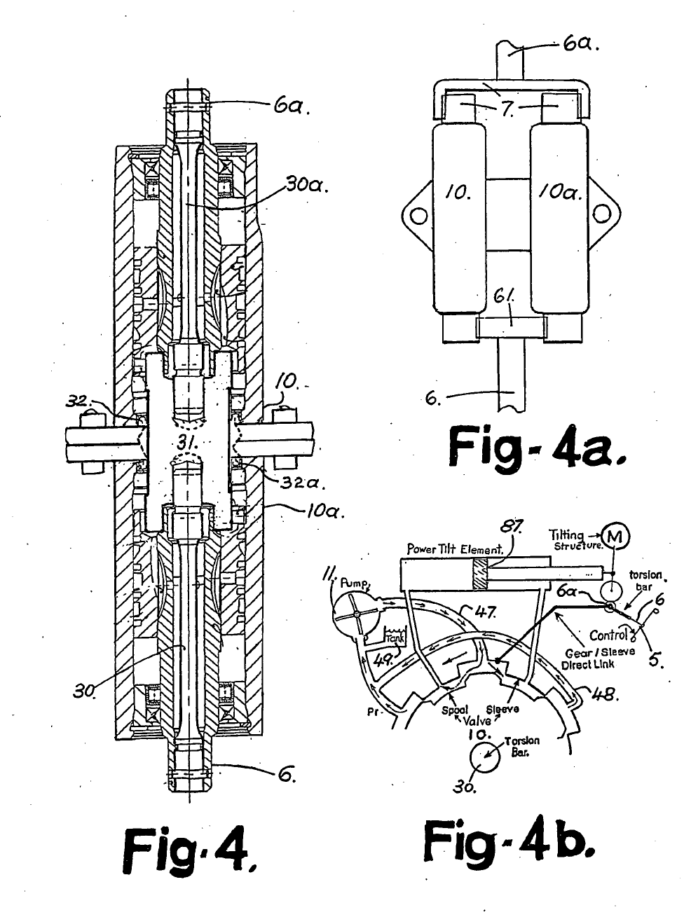

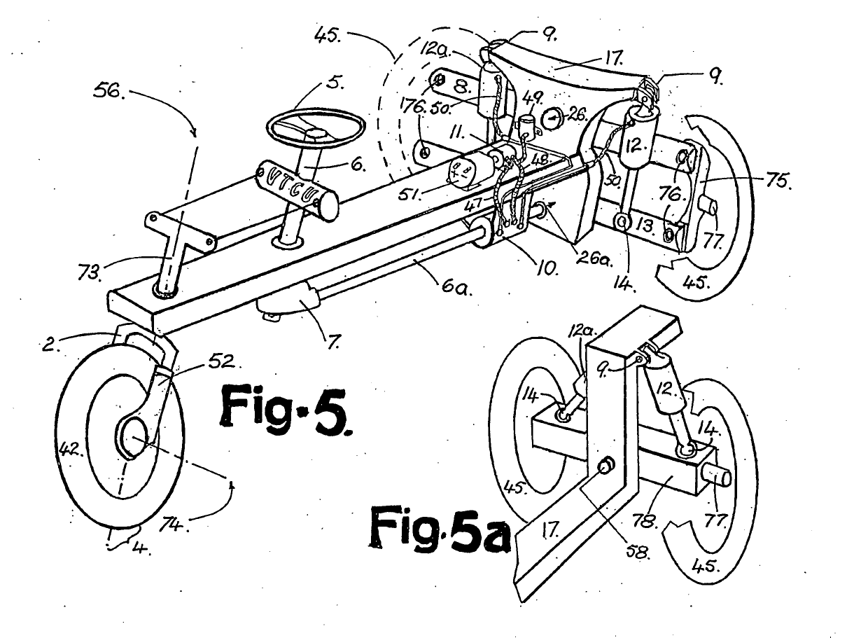

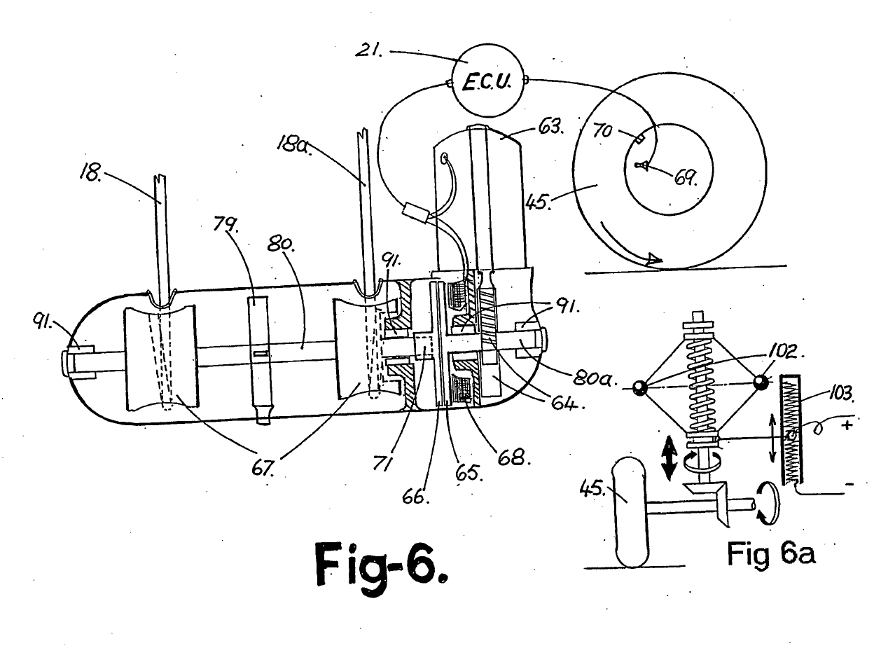

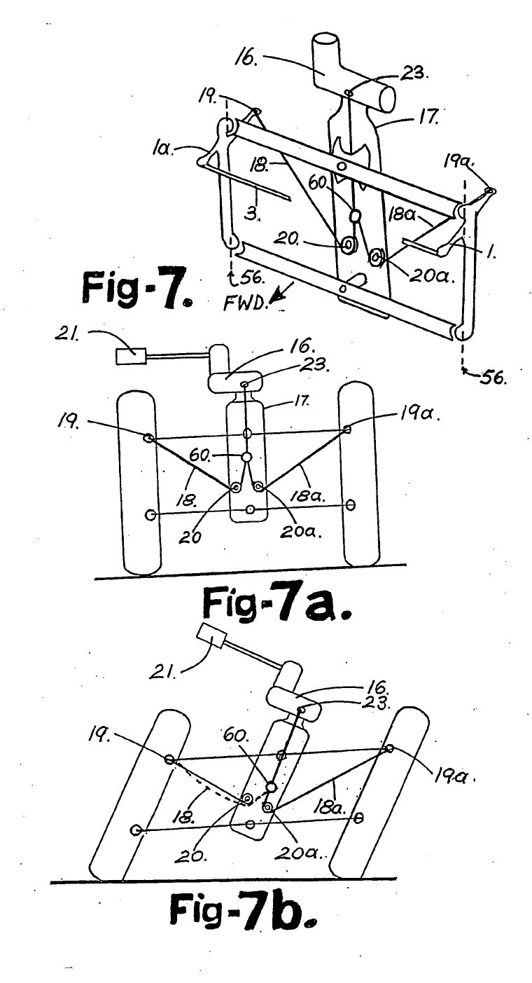

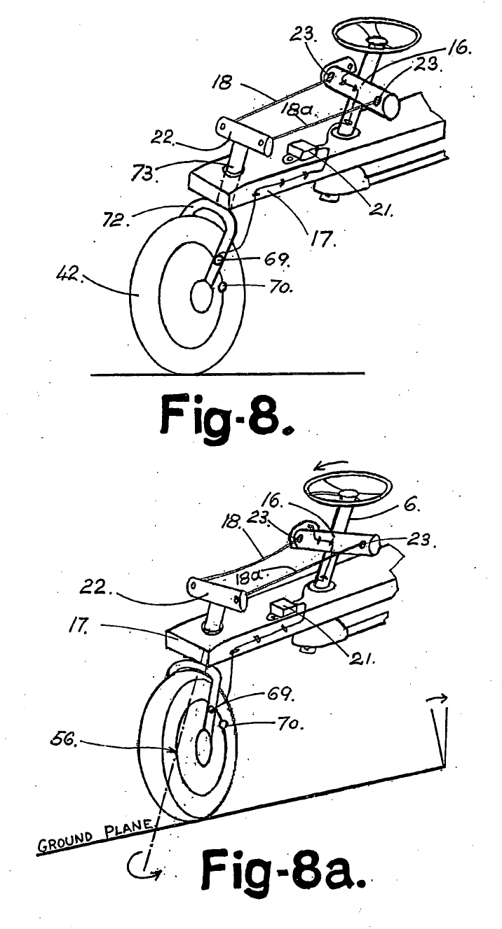

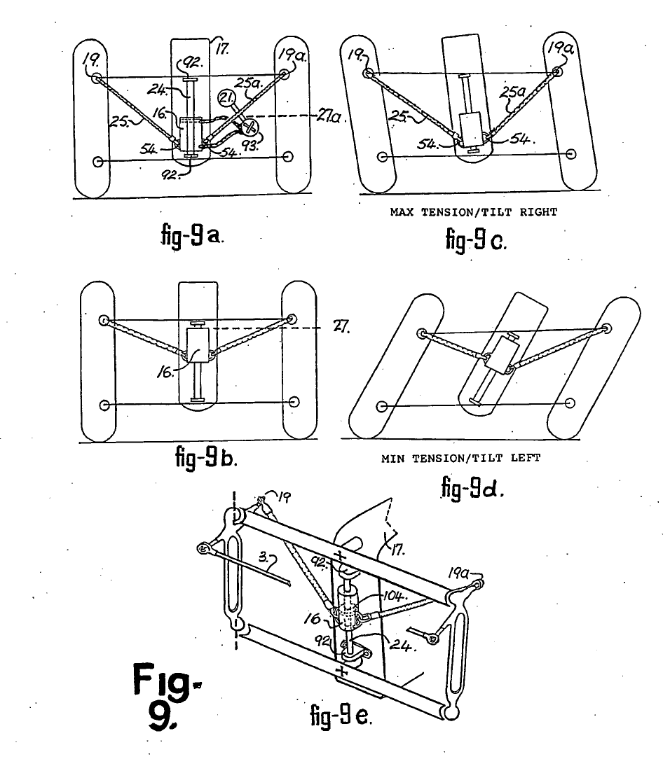

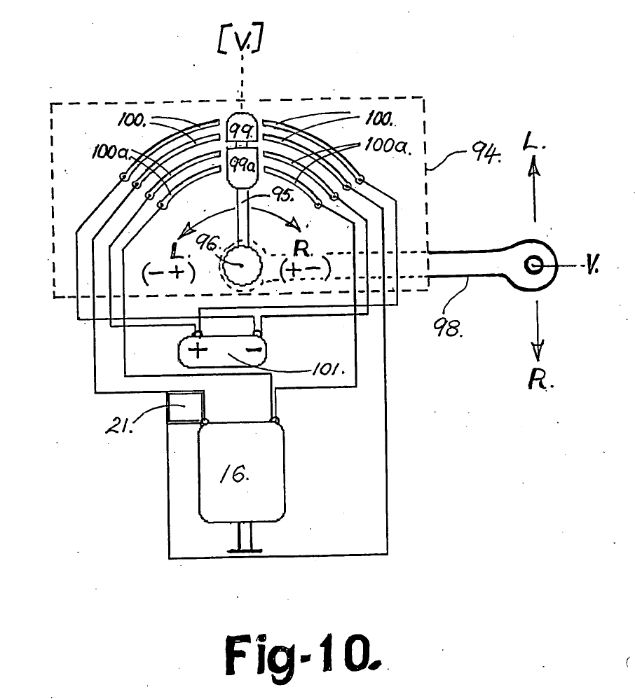

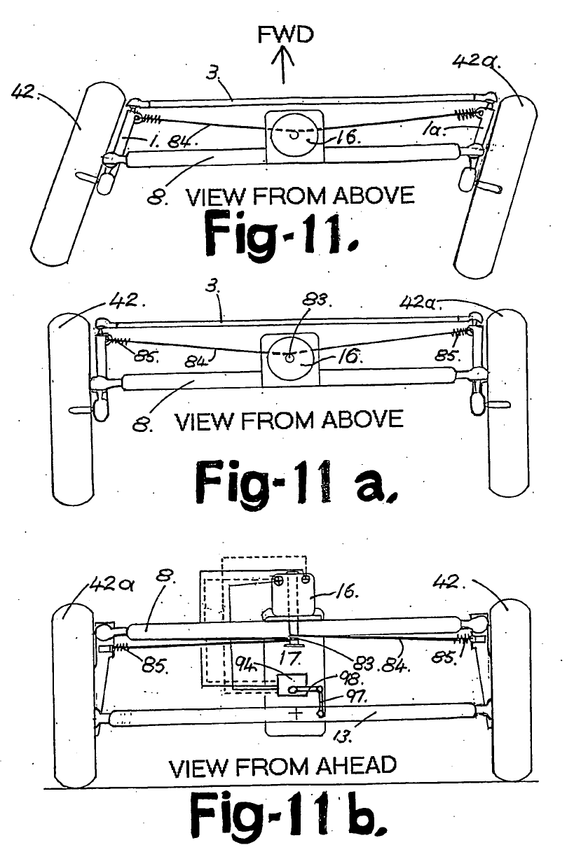

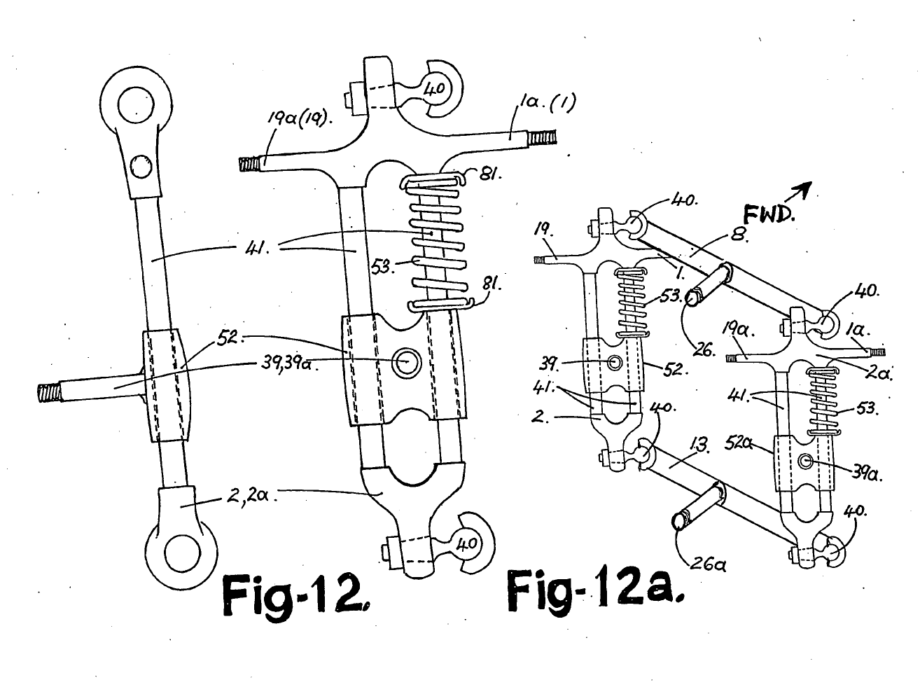

### FIELD OF THE INVENTION

This invention relates to the field of narrow tilting vehicles that have overall dimensions similar to a normal motorcycle, and which obtain their stability by inclination of the vehicle/occupant mass to offset the effects of centrifugal force when cornering. This invention sets out a simple system of control to replace the complex control used on a conventional motorcycle. This will enable the widespread use of narrow tilting vehicles by operators with common skills. The advantage of such a vehicle is the reduction of the energy required to transport the occupants, and the reduction of the space required to park the vehicle, combined with an incentive for the use of the vehicle due to its simple control and inherently satisfying dynamics. In order to achieve this ability the tilting vehicle described in this invention uses what is termed “simple steer”. The full control of the vehicle is achieved by the use of a single control, a displacement of the control producing a corresponding tilt of the vehicle, and a corresponding steered vehicle path. This creates automatic vehicle balance at all speeds and during all manoeuvres. The driver control can be identical to that of a conventional motorcar if desired. Many prior art vehicles use two controls, one for steering the road wheels and the other for tilting the vehicle. These control systems require unreasonable driver skill levels as does conventional motorcycle control, which although using a single control, requires a complex steer or fractured driver input method due to the need for the driver to balance the vehicle as well as to steer it.

The vehicle of this invention uses tilting and castoring wheel/wheels to create the steered vehicle path. The wheels tilt as the vehicle tilts but they are fundamentally free to adopt their steer angle due to dynamic forces, and so a single simple steer input to tilt the vehicle, creates a steered vehicle path which is automatically suitable for the vehicle tilt angle and the vehicle speed.

The conventional wisdom dictates that a narrow vehicle [say 1 meter or less in width], cannot be “force tilted” without creating an excessive overturning moment upon the vehicle as the force is applied. This is caused by the rest inertia of the vehicle mass resisting the applied force and leading to a sudden loading of the outer wheels. The problem is made worse if the front wheel/wheels steer into a curved path before the vehicle tilts into the curve, because this will create centrifugal force acting to tilt the vehicle in the wrong direction and further loading the outer wheels. All force tilted vehicles in the prior art suffer due to these problems. My invention uses the natural characteristics of castoring wheels to overcome prior art faults.

### DESCRIPTION OF THE DRAWINGS

The descriptions of the vehicle in the drawings are non limiting illustrative embodiments. In the drawings:

FIG. [1], [1a] shows an illustration of automatic out track reaction

FIG. [2] shows various tilting vehicle types.

FIGS. [3], [3a] shows the principle components of a vehicle of type [b].

FIGS. [4], [4a], [4b] shows two servo valves connected and a hydraulic servo circuit.

FIGS. [5], [5a] shows the principle components of a vehicle of type [d] or [e]

FIGS. [6], [6a] shows a variable force steer transmitter combined with two versions of a vehicle speed sensitive control signal transmitter.

FIGS. [7], [7a], [7b] shows a wheel control system as applied to a vehicle of types [a], [b] or [c].

FIGS. [8], [8a] shows a wheel control system as applied to a vehicle of types [d] or [e].

FIG. [9] shows a wheel control system as applied to a vehicle of types [a], [b] or [c].

FIG. [10] shows a tilt activated switch.

FIGS. [11], [11a], [11b] shows a variable force steer transmitter.

FIGS. [12], [12a], [12b] shows a suspension system applied to vehicles of type [a] [b] or [c].

### BACKGROUND TO THE INVENTION

I will briefly describe how a tilting vehicle with front castoring wheels will automatically steer its wheels upon the application of a force to initiate the tilt of the vehicle, and so reduce the force required to tilt the vehicle, and increase vehicle tilt speed.

In FIG. [1] an illustrative example is given. A force applied between the pivoting mass and the plank as depicted by the double pointed arrow, causes the plank to react and move as depicted by the single pointed arrow, and roll upon the rollers. The mass is allowed to tend to rotate around its centre of gravity. Transforming this understanding to the FIG. [1a] it will be seen that the reaction will be similar within a tilting vehicle parallelogram, which supports the wheels and allows the tilt of the vehicle, and if the wheels have a trail caused by the contact patch being behind the steer axis [in the example into the page], then the two wheels are caused to steer in the opposite direction to the direction of the force applied to tilt the vehicle mass. The mass is allowed to tend to rotate on its centre of gravity and so the force required to initiate tilt of the mass is reduced. The amount of steer imparted depends on the observed magnitude of the rest inertia of the tilting mass. If the support structure for laterally spaced wheels, within which the force to tilt the vehicle is applied, is placed at the rear of the vehicle with front wheel/wheels castoring, the result is similar. It is tempting to name this steer as “counter steer” however I will call this reaction “out tracking”.

A tilting vehicle with castoring front wheels will always tend to turn the wheels in the direction of any inertia load. In a slide/regrip vehicle capsize event the wheels will automatically “opposite lock” to stabilise the mass and prevent a vehicle capsize. This characteristic is fundamental to the vehicle. So, in either event of overcoming the rest inertia of the mass when initiating vehicle tilt, or stabilising the moving inertia of the mass during a slide/regrip, the wheels turn in the direction of the inertia load. These actions go unnoticed by the driver.

Multi wheeled tilting vehicles can take various forms. Please refer to FIG. [2]. Vehicle [a] has two front wheels tilting, two rear wheels not tilting. Vehicle [b] has two front wheels and one rear wheel, all tilting. Vehicle [c] has four wheels, all tilting. Vehicle [d] one front wheel tilting, two rear wheels not tilting, and Vehicle [e] has one front wheel and two rear wheels, all wheels tilting. The principle outlined in my invention can be applied to all vehicle types.

### PRIOR ART

The prior art that is most associated with my invention is contained in WO9534459. This describes a tilting vehicle where the driver input control position is compared to the position of a front wheel mounted on the tilting structure. A sensor compares the position of the driver input on the control relative to the front wheel position. The sensor directs power to tilt the vehicle. As the vehicle tilts due to driver input on the control, as observed by the sensor, the “castoring” wheel steers into a position until the wheel position matches the driver input position, as observed by the sensor. The vehicle then ceases to tilt and is then in a stable curved path. One disadvantage of this arrangement is that any mechanical connection between the driver input and the front wheel [via a torque sensing spring in the sensor], is detrimental to the performance of the vehicle due to a disturbance of the position of the wheel into a positive steer position before the application of the force to tilt the vehicle. In this prior art vehicle a torque sensing spring has been found to be necessary to prevent a “nervous vehicle reaction”. In this system no mechanical connection is possible between driver input and the vehicle tilting section. Inferior feedback methods are required and there appears to be limited failsafe capacity suitable for a narrow vehicle.

The fundamental character of the driver feedback is unlike that of a conventional car because the vehicle produces no feedback in a steady state condition, only upon the application of the driver input to perform a manoeuvre. My arrangement can provide direct mechanical failsafe capacity of the drivers influence on the vehicle tilt angle if desired, and the castoring wheel is allowed to out track upon driver input) to tilt the vehicle and also to opposite lock as required. It could be said that the prior art vehicle controls the tilt angle means as a function of bend radius [U.S. Pat. No. 6,435,522], whereas the vehicle outlined in my invention controls the bend radius as a function of the tilting means. In U.S. Pat. No. 6,435,522 this fact is illustrated. This patent shows an automatic steer device applied to the prior art vehicle. The novel methods employed to implement my arrangement are fully described in the body of this patent.

### SUMMARY OF THE INVENTION

The invention is summarised as a tilting vehicle with at least one section of the vehicle tiltable about the longitudinal axis of the vehicle, which tiltable section houses the driver and the drivers control.

The drivers control is connected to a support structure for laterally spaced wheels, to allow the driver to control the tilt angle of the vehicle.

The vehicle has at least three wheels, including wheels laterally spaced, at least one front wheel, and at least one rear wheel.

The vehicle is provided with a castoring element formed by one front wheel, or optionally two front wheels. The castoring element is able to tilt with the vehicle and is dynamically directionally controllable due to the tilt of the vehicle and the speed of the vehicle.

The vehicle is provided with a means to enhance low speed control. A variable force steer transmitter is connected to a register of tilt angle variation, and to the castoring element, so that a torque can be applied by the variable force steer transmitter, to resiliently urge the castoring element to steer in the same direction as the direction of the tilt of the vehicle.

Also the vehicle is provided with a vehicle speed sensitive control signal transmitter, which adjusts the magnitude of the force applied by the variable force steer transmitter according to vehicle speed.

Or, put another way: The vehicle has two fundamental requirements.

1] A method for the driver to control the tilt angle of the vehicle.

2] A method for the tilt angle of the vehicle to produce a steered vehicle path.

Optionally, additional to the fundamental arrangement, the vehicle is provided with a sensor for measuring the drivers input on the control to alter or maintain the tilt angle of the vehicle. The sensor is connected to a power assist tilt drive element, to allow power assisted driver control of the tilt angle of the vehicle.

Preferably the drivers control is a steering bar or steering wheel rotatable about a steering column, where a clockwise rotation of the control as viewed by the driver, produces a tilt to the right of the vehicle as viewed by the driver, and vice versa.

Preferably the drivers connection to the tilt action of the vehicle, the “tilt control means”, is by mechanical tilt control transmitting structure, however, other means of transmission can be employed, for example, hydraulic or electric transmission elements.

In one form of the invention the vehicle can be provided with two individual sensors and two individual power assist tilt drive elements.

Also the vehicle with two front wheels is provided with a tilting linkage structure incorporating wheel steer pivot suspension structures, which allows the wheels to tilt with the tiltable vehicle section and also allows the wheels to independently move in suspension in their inclined plane, such suspension movement being contained wholly within the steer pivot suspension structures.

### BEST WAYS TO PERFORM THE INVENTION

I will now describe the best way of performing my invention known to me when the vehicle has two front wheels and is operating above approximately 10 mph [16 kph]. The descriptions given include power assist tilt elements which are not absolutely necessary. The necessity depends on the vehicle mass, vehicle operating speed range, and the transmission ratio between control and tilt action. A vehicle with no power assist will be similar to the vehicle about to be described, with the power assist components removed. In FIG. [3] is shown a tilting vehicle of type [b] with a castoring element, in this case two front wheels [42,42a] [represented by dotted lines], that rotate on axles [39] [one visible] when the vehicle is under way. The axles attach to carriers [52,52a] sliding on parallel bars formed within the steer pivot suspension structures [2,2a], to allow suspension movement [as will be described in more detail later]. The wheels are arranged on either side of the centre of gravity with respect to the longitudinal axis of the vehicle, and are located on a support structure for laterally spaced wheels, in this case a parallelogram tilting linkage. The parallelogram is fitted to the front of the tiltable vehicle section [17], and one central rear wheel [45], allows the tiltable vehicle section to tilt in a longitudinal axis via the parallelogram tilting points [26,26a]. The parallelogram is rotatably attached to the tiltable vehicle section at points [26,26a] and the axes of rotation is nominally parallel to the longitudinal tilting axis of the vehicle, but this may be varied. Attached to the tiltable vehicle section is a drivers seat [43], and drivers control [5], in this case a steering bar rotatable around steering column (shaft [6]. An engine [44], drives the back wheel [45]. The parallelogram is formed by upper cross arm [8], and lower cross arm [13]. Both arms can rotate on bearings located in the centre of each cross arm that in turn locate on axles [not visible] attached to the tiltable vehicle section [17] at points [26,26a]. Ball joints [40], are fitted to the ends of each cross arm, and these joints attach to the wheel steer pivot suspension structures [2,2a], forming a parallelogram which can tilt, and simultaneously allowing the steering of the wheel pivot suspension structures, and so the wheels. The wheels are illustrated on right lock. The action of the tilting of the parallelogram and the action of the steering of the wheel pivot suspension structures are independent, one of the other. As the parallelogram tilts the upper and lower cross arms remain fundamentally parallel to the road surface and the vehicle tilting section tilts relative to the road surface. It could be said that the parallel cross arms form a non tilting section of the vehicle. The wheels incline relative to the road surface via the ball joints connecting the wheel pivot suspension structures to the ends of the cross arms, and the angle of inclination of the wheels is fundamentally similar to the angle of the inclination of the tilting vehicle section but this can be varied as desired by parallelogram geometry. The fundamental action of a tilting parallelogram can be observed in FIG. [9]. Referring back to FIG. [3], steer lever arms [1,1a] extend forward from the two wheel pivot suspension structures [2,2a], and are pivotally connected by a track rod [3] which maintains the wheels in the desired alignment. As will be described later, the vehicle is provided with a means to force it to tilt due to driver input on the control [5], and because of the parallelogram linkage when the vehicle tilts the wheels also tilt. The wheels are arranged to operate with a trail [4] so providing a castoring action. The trail is provided by arranging the geometry so that the tire contact patch in each wheel is rearward of the point where the extension of the king pin axes, formed by the upper and lower ball joints on the wheel pivot suspension structure, would strike the road surface. As is well understood generally, the forward motion of a tyre on a road surface may provide the trail on a pneumatic tyre. This “pneumatic trail” could provide the castoring action of the tyre although there may be no static trail on the vehicle wheel geometry. In all references to “trail” or “castor” in this patent it should be understood that the trail or castor could be a static or dynamic state.

Where trail is illustrated in the drawings it depicts either a static geometrical condition or a dynamic pneumatic condition. The magnitude of the trail may be similar to that of a conventional motorcycle, but this can be varied. When the vehicle is tilted the front wheels also tilt and this causes the front wheels to dynamically steer into the direction of the tilt. As the vehicle tilts the front wheels take up a steer angle that produces and maintains a steered vehicle path that is fundamentally suitable for the tilt angle of the vehicle and the speed of the vehicle. The vehicle will be fundamentally balanced at all times, however, it is a natural characteristic of the arrangement that the vehicle will always tend to return to the vertical position. As previously mentioned the vehicle is arranged to tilt by direct influence from the driver using a control element, optionally a steering wheel or a steering bar rotatable around a steering column. In FIG. [3] is shown a control [5], connecting shaft [steering column] [63], universal joint [46], and gear set [7]. The natural rotation characteristics of a universal joint operating at an angle can be utilised to provide a variable transmission ratio between control rotation and vehicle tilt rotation. In the gear set, one gear is attached to the upper parallelogram cross arm [8], and the other to the shaft [6a], providing a mechanical connection between driver input on the control and the vehicle tilting action. Any other arrangement can be provided which produces a connection between driver input and vehicle tilt action the connection being described as “tilt control means”. Also shown are two sensors, optional to the fundamental arrangement, in this case, hydraulic servo valves [10,10a] fitted between the shafts [6] and [6a]. The valve bodies are mounted to the tiltable vehicle section. One sensor can be used [as described later] or two sensors can be used as shown, to provide additional amplified force to the tilting of the vehicle in the event of a failure of one or the other of the individual power tilt drive elements that operate upon the signal provided by the individual sensors. Please refer to FIG. [4b] to view a schematic illustration of the fundamentals of a closed loop hydraulic power assist tilt drive system with mechanical feedback. In the system about 80% of the tilt force comes from hydraulic assist and the remaining from driver input torque on the control [5], but this may be varied as desired. In the neutral vertical vehicle position a vane pump [11], which is driven by the engine [or other means], circulates fluid in a circuit which includes a tank [49]; the vane pump [11] [which incorporates flow control and pressure relief]; supply and return lines [47,48] and; a rotary spool valve [servo valve] [10]. When the control is moved by the driver to tilt the vehicle the servo valve diverts the supply line fluid flow to either side of the power tilt drive element actuator piston [87], for a corresponding right or left tilt of the vehicle. At the same time the servo valve passes an equal amount of fluid from the other side of the piston via return line to the tank. This produces differential pressure acting on the piston and creates hydraulic power assist. The hydraulic power assist is proportional to the diverted fluid flow rate from the supply line by the servo valve and is controlled by the relative angle between the steering wheel shaft [6], and gear drive shaft [6a]. This valve relative angle is equal to the twist angle of the torsion bar [30]. The torsion bar connects the shaft [6], to the shaft [6a]. Torsion bar stiffness yields the drivers steering effort. During on centre operation the servo valve generates an opposing force to power tilt element piston motion, caused by loads from the tilting vehicle mass.

An illustration of the connection of two sensors, in this case hydraulic servo valves [which are in this case identical to power steer rotary spool valves], is made with reference to FIGS. [4,4a]. In FIG. [4] the individual servo valves are connected via flanges and are arranged so that the input shaft [6] shares a common axis with the output shaft [6a]. The torsion bars [30,30a] are fitted so as to operate as one torsion bar being connected by common support [31]. This common support has seals [32,32a], which prevent fluid flow from one valve to the other. Each torsion bar will twist and cause the valves to displace and open under influence supplied as a torque to the input or the output end of the shaft. Mechanical valve stops are fitted in both valves so as to provide a locked mechanical transfer upon the designed full displacement of the torsion bars, ensuring that full mechanical torque can be applied through the system upon the failure of one or all of the components. This is a standard feature of power steer valves. It is also possible to arrange for the two servo valves to be connected by a method described in FIG. [4a]. In this schematic diagram the two servo valves [10,10a] are placed side by side and driven by gears commonly engaged by a gear [61] on the input shaft [6]. The output shaft [6a] is driven by gear set [7] which drives the tilt angle of the vehicle. In this example the servo valves operation is identical to the method described in FIG. [4], however the transmission ratio between the driver control element rotation and the vehicle tilt rotation can be achieved by various matchings of the diameters of the various gears which will be obvious to those skilled in the art. It is also possible to construct the servo valves arranged as in FIG. [4a], to operate without any torsion bars. In this case the valves respond to the direction of the load and not to the magnitude of the load.

Please refer back to FIG. [3]. Each hydraulic section of each servo valve [10,10a] is connected to separate power assist tilt drive elements, in this case double acting hydraulic actuators [12,12a], to power assist the driver's effort to tilt the vehicle, and separate pumps [11,11a] supply each servo valve. The fundamental valve design shown is a standard power steer valve well known in the art. My preferred embodiment with power assisted tilt is based on standard automotive power steer components. The servo valves and pumps are identical in all respects to power steer valves and pumps and no detailed description of their construction is given on this basis. Obviously other forms of valves and components will be used if the chosen system is not hydraulic but instead say, electric or pneumatic. It is also possible to use sensors or valves which are linear in action, for example conventional spool valves which allow a linear sliding of components. Optical sensors can also be used. In the FIG. [3] a hydraulic system is illustrated. Each servo valve is connected to its own fluid supply pump [11,11a], by connecting delivery lines [47] and connecting return lines [48]. Each return line incorporates a filler tank [49] [one tank shown]. Each servo valve directs fluid to its own double acting actuator [12,12a] via lines [50]. The application of driver torque/displacement on the control [5] is sensed by the servo valves which direct fluid under pressure by delivery lines [50] to the actuators, to cause the actuators to apply a force to tilt the vehicle via the parallelogram, to power assist the drivers effort. If the applied driver torque on the control is clockwise as viewed by the driver, the applied force by the actuators causes the vehicle mass to tilt to the right as viewed by the driver, and vice versa. Any loads coming from the vehicle mass back to the driver control, will likewise be sensed by the servo valves and the servo valves will direct fluid to power assist the resistance to the altering of the mass tilt angle position relative to the drivers applied position on the control. In all respects this is a simple closed loop hydraulic servo system with mechanical feedback well understood in the art. When I use the term actuator in a hydraulic system I refer to a cylinder/piston assembly. The actuators are mounted as shown, each with the actuator housing located to pivot on the tiltable vehicle section at points [9], and the actuator shaft located to pivot on the lower cross arm [13] at points [14], on a rearward extension of the cross arm, and so to provide a means to apply a force to assist the drivers effort to rotate the parallelogram around points [26,26a], and so to tilt the vehicle. In FIG. [3] the view of the second actuator [12a] is obscured. The obscured actuator is in all respects similar to the actuator [12], and is attached to the vehicle tilting section [17] and the lower cross arm [13] in an identical manner to actuator [12]. In FIG. [3a] is shown an overhead view of the two actuators [12,12a], servo valves [10,10a], and pumps [11,11a], and connecting lines, the view being a schematic representation of the arrangement of the various components. Of course the parallelogram cross arms remain horizontal to the road surface being supported in that plane by the laterally spaced wheels, and the force applied causes the tiltable vehicle section to tilt. The power system and its origins may be varied between one style and another. For example, a hydraulic pump engine driven [11], and an electric system operating off the vehicle battery, or an arrangement where one pump is engine driven [11], and the other pump driven off the vehicle transmission [11a], as desired. The position of the actuators or power assist tilt drive elements, the style of the driver input connection to the tilting vehicle action, the pump arrangements, and the style of sensors may be varied. Finally in FIG. [3] is shown a tilt lock operating lever [88] that allows the driver to lock the vehicle tilt position by locking the steering shaft [6] to the shaft support bracket [89]. The driver engages this lock prior to exiting the vehicle. The lock can be provided by any convenient method, for example by a drum brake with backing plate mounted to the bracket [89] and drum [90] mounted on the shaft [6].

I will now describe another way known to me to perform the invention with a vehicle with one front wheel forming the castoring element. In FIG. [5] a vehicle of type [a] is shown. In this case there is one front wheel [42], operating on a trail [4]. The wheel is attached to the tiltable vehicle section [17]. The wheel rotates on an axle [not visible] on axis [74] supported in the sliding wheel carrier [52] [one side obscured], which slides on the forked steer pivot structure [2]. Suspension is arranged by providing a suspension element between the wheel carrier and the forked steer pivot structure. This style of suspension is well known and is identical in all respects to conventional motorcycle fork, suspension, and will not be described any further. The overall structure is a steer pivot suspension structure. The fork extension shaft [73], is supported in the tiltable vehicle section on bearings [not shown] to allow the front wheel to steer on axis [56]. Two rear wheels [45] are arranged on either side of the centre of gravity with respect to the longitudinal axis of the vehicle and are supported on a support structure for laterally spaced wheels, in this example a parallelogram tilting linkage. The vehicle tilts in a longitudinal axis around points [26,26a] on the rear parallelogram, the vehicle tilting section being rotatably connected to the parallelogram with axes of rotation substantially parallel to the longitudinal axis of the vehicle. The rear wheel support uprights [75] [one shown] are attached to the parallelogram cross arms at points [76], the uprights and the cross arms being rotatably connected, and the axes of rotation being substantially parallel to the vehicle longitudinal axis, so the parallelogram and wheels can tilt but the wheels are maintained in directional alignment parallel to the vehicle longitudinal axis. The wheels rotate on axles [77] [one shown], attached to the uprights. The “tilting control means” connects the driver control element to the tilt action of the vehicle. In this example a mechanical connection leads via shafts [6] and [6a] to the lower parallelogram cross arm [13] where the shaft is locked to the cross arm, and so the driver input rotation on the control is locked to vehicle tilt angle. In series in these shafts is gear set [7], and a single sensor [10], in this case again a hydraulic servo valve. The valve body is mounted to the tiltable vehicle section. The gear set may be used to vary the transmission ratio between control element rotation and vehicle tilt angle rotation, and also provides a convenient way to connect shaft [6] to shaft [6a]. The relative positions of the gear set and the servo valve can be varied. The actuators [12,12a], form the single power assist tilt drive element, and are in this case single acting and are shown attached to the tiltable vehicle section at points [9], and to the lower parallelogram cross arm [13] at points [14] [one point obscured], to allow a force to be applied to tilt the tiltable vehicle section [17]. Also is shown a hydraulic pump [11], driven by an electric motor [51], powered by the vehicle battery [not shown]. Connecting lines [delivery and return] [48, 47], are shown between the pump and the servo valve with a filler tank [49] incorporated in the return line. The general operation of the hydraulic system is identical to the system described in FIG. [3,3a]

The rear wheels may just as readily be attached to a support structure for laterally spaced wheels which does not allow the wheels to tilt, but maintains them in a substantially vertical position. See FIG. [5a] [vehicle type d]. In this example the actuators [12,12a] which are in this illustration also single acting, are placed within the rear wheel support structure attached to points [9] [one point obscured] and [14] in a way which allows a force to be applied between the tiltable vehicle section [17] and the ground reference created by the laterally spaced wheels[45]. The vehicle tilts around the longitudinal pivot axis at point [58]. The rear wheels are retained in position running on axles [77] [one shown] at each end of beam [78]. The beam becomes a non tilting section of the vehicle.

I will now give a description of vehicle operation above approximately 10 mph [16 kph], operating with hydraulic power assist and mechanical feedback. This description applies to all styles of vehicles FIG. [2,a,b,c,d,e.]. In a steady state vertical position under way, the vehicle will steer a straight course. The vehicle will steer straight even with the driver's hands off the control. In this steady state hands free condition the directional stability is achieved by the natural tendency of the vehicle to seek a vertical position. If the vehicle tends to fall, say right, the front wheel/wheels turn into the fall and countersteer the vehicle back to the vertical. This characteristic is identical in all respects to “hands off” stability on a conventional motorcycle. When the driver wishes to turn say right, he applies a force to displace the control to the right, which causes the vehicle to tilt right. The tilt to the right causes, or tends to cause, the vehicle front wheel/s to steer to the right due to a number of factors, including gyroscopic steer and the effect of a load [in this case gravity/centrifugal force] applied offset to the side of the king pin axis of the castoring wheels. At the same time the previously mentioned automatic out track effect will/may occur, more, or less, depending on the driver input speed on the control and so, the observed rest inertia of the tilting mass. The wheels seek a point of equilibrium and steer into a stable curved path where they are maintained by the camber steer forces acting on the tire contact patch. The stable curved path is a function of vehicle tilt angle and vehicle speed. In the hands off state the vehicle returns to vertical. The fundamental difference between this vehicle and a normal motorcycle is that in a normal motorcycle there are no laterally spaced wheels, and the driver has to countersteer the control to effectively tilt the mass centre. As previously mentioned the countersteer may re emerge as out tracking in this system of my invention due to the forcing of the mass to tilt. A closer examination of a right turn is that as the driver applies a torque to steer the control right the vehicle mass resists displacement and causes the reaction spring in the sensor servo valve to twist and to crack the valve. The valve then directs fluid to the actuators to cause a force to tilt the vehicle to assist the drivers applied torque on the control. After any out track reaction has been injected the process develops, and the wheels steer into the direction of the tilt, creating a vehicle curved path and also creating a counter tilt torque acting against the driver applied torque on the control. In this way the driver experiences feedback via the natural forces created in the system and the servo valve responds as required to produce a smooth controlled transition from one vehicle steady state to another. In the tilting steady state the driver will experience a torque on the control tending to return the control to the central straight ahead position. This is discussed in more detail later.

And so it can be arranged that the control of the vehicle has identical characteristics to that of a conventional motorcar, so allowing persons with common skills attained in a conventional motor car to easily perform the control. When the vehicle is at rest the driver retains control of the vehicle tilt, and if he removes his hands from the control the vehicle seeks the vertical position due to a weighted element under the influence of gravity, optionally a simple lead weight on the steering wheel rim, or some such arrangement, which effect is amplified by the powered tilt servo system. When the driver wishes to exit the vehicle he applies the tilt look and locks the vehicle to the vertical, or otherwise as required.

As described so far the directionally controllable castoring element is free to respond to the dynamic conditions. However, as speeds drop towards about 10 mph [16 kph] the strong dynamic bond between vehicle tilt angle and the castoring element steer angle, starts to break down. This breaking down is progressive, and becomes more obvious as speed drops to around 5 mph [8 kph], until there is a poor relationship at dead slow. However of course, the driver always retains control of the vehicle tilt angle so the situation is still manageable. Additional steer location for the castoring element is required for speeds below approximately 10 mph [16 kph], and this additional location can be applied progressively from a higher speed so that the driver is totally unaware of any transition.

One way to achieve this low speed control is to apply a torque to the steer axis/axes of the directionally controllable wheel/wheels by a variable force steer transmitter, so that the wheel/wheels is/are resiliently urged to steer in the same direction as the direction of the tilt of the vehicle tilting section. The dynamic tendency for the front wheel/s [castoring element] to steer in the direction of the vehicle tilt exists at “dead slow” speed, but is not developed due to friction between the tyre and the road surface, inertia of the steerable parts, and a lack of the strong dynamic forces which dominate the process at higher speeds. The variable force steer transmitter overcomes these problems by encouraging the front wheel/wheels to steer in response to vehicle tilt at lower speeds.

Please refer to FIG. [6]. Briefly the variable force steer transmitter can be a variable coupling well known in the art. A rotating input shaft, driven by for example, a geared electric motor, can be used as a source of torque. The torque is delivered to the output shaft via a variable coupling transmission. The variable transmission can take many forms, magnetic friction, mechanical friction, viscous friction or magnetic particle friction etc etc. Controlling the transmission varies the output torque. A convenient way to vary the transmission of the torque is by a vehicle speed sensitive control signal transmitter, for example, a vehicle electronic control unit [ECU] which may, for example, vary the voltage applied to a magnetic clutch. The term “Variable Tension Control Unit” [VTCU] applies to the descriptions I will be giving which use tension control of cords which are drawn into the VTCU by winch drums driven by and incorporated within the unit. If other types of arrangements are contemplated the unit might be applied as a “Variable Torque Control Unit” or a “Variable Force Control Unit”. The term “variable force steer transmitter” covers these variations and this term is used in the appended claims. To assist the reader FIG. [6] is included which is an illustration of a variable tension control unit [VTCU] The electric motor [63] drives gears [64] to turn clutch plate [65] via shaft [80a] supported to rotate in bushes [91]. A worm gear is attached to the output shaft of the motor and this drives the gear attached to the shaft [80a] to create a large reduction ratio, to enable a small electric motor to produce a large torque on the shaft [80a]. An air gap/visdous gap exists between clutch plate [65] and the clutch plate [66]. Clutch plate [66] drives the winch drums [67] via shaft [80], supported to rotate in bushes [91].

When the electric motor is active, simultaneously an electric winding [68] is excited by electric current, to create a magnetic attraction of clutch plate [66] onto clutch plate [65] by for example, providing a small end float of the clutch plate [66] on the winch drum shaft via a sliding spline section at point [71]. This creates friction between the two plates and allows the transfer of torque to the drums. The torque is variable by varying the voltage to the windings, which varies the magnetic attraction between the clutch plates and varies the friction between the clutch plates. The cords [18,18a] are wound and locked to the drums [by any suitable means] and so a tension is created in the cords [the cords being attached to a load], according to the voltage applied to the windings. There may be a central winch drum with one cord as required. A wound torsion spring [79] is fitted to engage on the winch drum drive shaft [80] and also to engage to the VTCU housing. The spring is suitably sprung to load the winch drums so that during a non active VTCU state there is a small residual tension maintained on the cords. Sufficient cord must be stored on the winch drums to allow withdrawal of cord during various tilt/steer combinations. Also illustrated is a vehicle speed sensitive control signal transmitter, in this example, a vehicle electronic control unit [ECU] [21]. The unit senses the speed of the vehicle by sensor [69] [attached to a non rotating part of the vehicle], noting the rotation of the road wheel [45] by magnetic pulse from the magnet [70] attached to the wheel. The ECU varies the voltage supplied to the windings [68]. In FIG. [6a] is a schematic illustration of a mechanical speed sensitive control signal transmitter, formed by the road wheel [45], driving and rotating weights [102], which react and move a potentiometer [103], which varies voltage signal according to vehicle speed. These systems are well known in the prior art.

I will now give a description of the best ways known to me to perform the low speed control of the vehicle previously described in FIG. [3]. In FIG. [3] the VTCU was shown mounted within the subframe with two separate cords entering the VTCU housing. In the following description the parts have been arranged for clarity, the operation is identical. FIGS. [7,7a,7b] are basic diagrams showing the layout of a system in a vehicle with two front wheels. Track rod [3], connects steering lever arms [1,1a], but for clarity this item and others are omitted from FIGS. [7a,7b]. The VTCU [16], is mounted on the tiltable vehicle section [17]. Equal length cords [18,18a], run in pulleys [20,20a], then pivotally attach to wheel steer lever arms [19,19a], with suitable fittings, [not shown]. The arms [19,19a] extend rearwardly from the steer axis [56]. The pulleys are mounted to the tiltable vehicle section. The cords are attached to the VTCU via a connection [60] that joins cords [18,18a] into a single cord that is drawn into the VTCU winch drum through an opening in the VTCU at point [23]. In the vertical straight ahead position FIG. [7,7a], imagine a tension applied by the VTCU on the cords [18,16a]. The tension is equal in both cords and so the wheels are resiliently positioned straight ahead, being maintained in alignment by track rod [3]. If the vehicle is tilted to the left FIG. [7b], the cord [18a] maintains tension on the wheel set and the tension in cord [18] is removed. Cord [18] may play no part in the process as indicated by the curved dotted line. The wheels are resiliently directed to steer in the direction of the vehicle tilt and the magnitude of the urging depends on the tension applied by the VTCU as controlled by the ECU [21], according to vehicle speed. Cord [18] plays no part until the vehicle is tilted in the other direction when a mirrored effect occurs. The attachment points for the cords on the steer lever arms [19,19a] are higher than the running points on the pulleys [20,20a], and so as the vehicle tilts, the distance between the attachment point on the steer lever arm and the pulley on one side increases, and the distance between the attachment point on the steer lever arm and the pulley on the other side decreases. A tension is maintained between the pulley and lever arm on one side only. The pulleys become “the register of tilt angle variation”. At “dead slow” the system will tend to maintain a “mechanically fixed” tilt/steer ratio with both cords in tension, this tilt/steer ratio depending on the distance between the cord attachment points on the steer levers [19,19a] and the pulleys [20,20a] as the vehicle tilts, as is obvious in FIG. [7b]. In FIG. [7b] the vehicle is shown tilted but the wheels are shown steering straight. Imagine increasing the tension applied by the VTCU, [vehicle speed reducing] and so increasing the tension in cord [18a], which will cause the wheels to steer in the direction of tilt, until cord [18] returns to tensioned. Both cords come into tension at “dead slow”, at a tilt/steer ratio which is a product of the geometry of the various points within the parallelogram as the parallelogram tilts. As a guide a “dead slow” tilt/steer ratio of around 1:3 should be considered, that is, for every 1 degree of tilt the geometry produces 3 degrees of steer, but this can be varied. The effective length of the steer lever arms [19,19a] must be taken into account along with the tilting geometry. If the attachment points for the pulleys [20,20a] are moved closer to the ground the “dead slow” tilt/steer ratio is altered to increase the steer for any given tilt [and vice versa]. Provision for adjusting the heights of the pulleys should be made. As speeds increase the ECU progressively relaxes the tension supplied by the VTCU so reducing the degree of positive location and allowing the speed generated dynamics of the castoring wheels to assert their control. And so the wheels develop from a condition of being restrained into position, in a relationship with tilt, at low speed, to a condition of being directed as speeds increase. While an unavoidable degree of experimentation must be undertaken to achieve the optimum results, the system will function over a wide range of settings.

Another variation of low speed control is now described in reference to FIGS. [8,8a], a vehicle with one front wheel [42] [type d, e]. In this arrangement the front wheel control is provided by cords [18] and [18a] connected between the winch drums in the extremities of the VTCU [16] through openings in the body of the VTCU at points [23] [drums not visible], and the cross arm steer lever [22] on the front wheel steer axis [56]. Both winch drums are driven by a common drive shaft. Again, the magnitude of the tension applied to the cords by the VTCU [16] is variable according to vehicle speed by a suitable ECU [21]. Also shown is an electrical connection between the VTCU, the ECU and its wheel rotation sensor [69] which detects the passing of the magnet [70] as the wheel [42] rotates. The VTCU is attached to the shaft [6], which is a register of tilt angle variation. The distance between the running points [23] on the VTCU, is greater than the distance between the attachment points on the cross arm steer lever [22]. This is required to produce the “dead slow” tilt steer ratio as was described in the previous example in FIG. [7,7a,7b]. The general comments made then apply equally to this example except that the geometry which drives the process is found in the relationship between the rotation of the VTCU via shaft [6], and the rotation of the cross arm steer lever around axis [56]. As a guide the distance apart of the attachment points on the steer lever [22] should be approximately 70% of the distance apart of the running points [23] on the VTCU, and this assumes a control rotation to vehicle tilt rotation ratio of 2:1, and a front wheel steer angle of 20 degrees on full lock. Again, provision for adjustment of the distance apart of the attachment points on the cross arm steer lever should be provided. The cross arm steer lever [22] is directly connected to the front wheel [42] via fork [72]. The fork extension shaft [73], is supported in the vehicle tilting section [17] on bearings [not shown], to allow steering of the front wheel around steer axis [56]. Again, imagine the two cords [18,18a] in tension with the vehicle in the vertical position, FIG. [8]. The vehicle front wheel is resiliently positioned to straight ahead. If the vehicle is tilted to the left [as depicted by the arrows] in FIG. [8a], cord [18a] remains in tension while cord [18] slackens. The front wheel is resiliently directed to the left, and when the vehicle is tilted the other way a mirrored effect occurs. In the examples outlined at times there will be a non active cord. The non active cord has been depicted in the drawings in a hanging curve but this can be avoided if desired. Generally, the cords can be any flexible high strength cord, and a resilient element can be attached to the cord at intervals while the resilient element is in a stretched condition. This allows the resilient element to gather the cord when the cord is not in a loaded condition. Other methods can be used.

An alternate version of low speed control of a similar operation is shown in FIGS. [9], [9a, 9b, 9c, 9d, 9e,] [Views from ahead] In FIGS. [9a, 9b] is shown a representation of a parallelogram leaning linkage supporting a laterally spaced wheel set. Note: A track rod [3] not shown in FIGS. [9a, 9b, 9c, 9d,], is observable in FIG. [9e]. A variable, force steer transmitter, in this example an actuator body VTCU [16] is arranged to run on the actuator shaft [24], the shaft being fixed to the tiltable vehicle section [17], at points on each end of the shaft by locating blocks [92]. The movement of the actuator is controlled by the vehicle speed sensitive control signal transmitter, again in this example an ECU [21], controlling a pump [93]. The actuator is a hydraulic double acting piston/cylinder assembly. The piston, FIG. [9e] [104], being fixed to the shaft [24], so the cylinder [actuator body VTCU] moves under influence from the pump, depending on the direction of rotation of the pump as controlled by the ECU. The principles of position control systems such as this are well understood in the art. Two resilient cords [25,25a], are pivotally attached to the actuator body at points [54,54], then pivotally attached to the wheel steer levers [19,19a] [obscured but visible in FIG. [9e]]. The energy stored in the resilient cords is produced by the distance between the actuator body attachment points for the cords and the steer lever arms. In the vertical vehicle position FIG. [9a], the tension in each cord [25,25a] is equal. As the vehicle tilts, say to the right as depicted in FIG. [9c], the distance between the attachment points on the actuator [54], and the attachment points on the steer levers [19,19a] varies on either side. The tension in cord [25] increases and the tension in cord [25a] decreases and a bias of tension is created to position the wheels in the direction of the vehicle tilt, [the steering arms being extended rearwardly from the king pin axis]. In the other direction of tilt a mirrored effect occurs. When the actuator body is positioned in the fully down position FIG. [9a] [27a] the tension created in the resilient cords is at maximum and the variation in the fitted length of the cords is greater for any given tilt. This is the “dead slow” vehicle speed setting and the positioning of the wheels to steer with the tilt is at maximum. When the actuator body rises say to position FIG. [9b] [27], there is less bias of tension created during vehicle tilt because the distance between the attachment points on the actuator and the attachment points on the steer lever arms varies less with vehicle tilt, and in the raised actuator position there is less stored energy tension in the cords, and so the urging of the wheels to steer with the tilt is at minimum. One important aspect of this particular arrangement is that unlike the previous examples, there is always tension in both cords. This means that positioning torques are always applied to the wheels which tends to maintain the wheels in a resiliently held steer angle position according to vehicle tilt angle position and vehicle speed. In the previous examples the torque applied could be primarily a directing torque, except during “dead slow” operation and in the vertical vehicle position, where the wheels were tending to be position controlled. In the example just described the resilient cords [25,25a] are considered a component of the VTCU. Any form of resilient “cord” can be contemplated. For example, rubber or metal tension spring. A rubber based cord is illustrated. Suitable fittings are well known. Experimentation will establish the optimum resilient characteristics, but the system will function over a wide range of settings.

All of these low speed systems are fundamentally similar and rely on the position of the attachment points/running points on the register of vehicle tilt variation being arranged relative to the position of the attachment points on the wheel/wheels steering arm/arms, so that as the vehicle tilts a bias of tension is switched to resiliently urge the vehicle wheel/wheels to steer in the direction of vehicle tilt, and the variable tension is supplied by the variable force steer transmitter and the amplitude of the tension is controlled by the vehicle speed sensitive control signal transmitter.

When these systems are correctly adjusted the driver experiences sharp and accurate steer in the 0 to 10 mph [16 kph] speed range in response to his control inputs to tilt the vehicle, and the transition from tension assisted control to free to castor steer is unnoticeable.

Fundamental adjustment of the system is as follows. With the vehicle moving at “dead slow” speed the variable force steer transmitter output is adjusted until a smooth controlled relationship occurs between vehicle tilt action and castoring element steer action. In practise this will require that the vehicle tilt angle is more than the technically correct tilt angle and the vehicle will “over tilt” at these speeds. A vehicle tilt angle of say 7 degrees may correspond to a wheel steer angle of say 20 degrees [full lock]. Experimentation will indicate the rate at which the torque applied to resiliently steer the wheels by the variable force steer transmitter should be relaxed as speeds increase. The electronic control unit is programmed to perform this function. Many other methods may be employed to achieve the control principle. The translation of the forces can be achieved by mechanical, hydraulic, pneumatic or electrical means. In the variable force steer transmitter systems just described, a tension is maintained in the steer transmitting structure [cords], the tension being switched to cause left or right urging of the wheel/wheels, the switching being activated by the tilting of the vehicle. Other similar switching systems can be employed, for example an electric current can be switched to drive a variable force steer transmitter, so that in the vertical vehicle position no electric current is supplied to the variable force steer transmitter but as the vehicle tilts left, current is supplied to the variable force steer transmitter to cause a resilient urging of the wheel/s to steer left, and as the vehicle tilts right, a current of reversed polarity is supplied to the variable force steer transmitter to cause a resilient urging of the wheel/s to steer right.

In FIG. [10] a schematic simplified illustration of the switching principle is shown. In the switch [94], the wiper arm [95], is attached to a rotatable shaft [axis 96], the rotation of the shaft being coupled to the rotation of the lower parallelogram cross arm via lever arm [98], attached to the shaft [axis 96]. The switch is mounted on the tiltable vehicle section. On its extremity the wiper arm [95] has two separate and electrically isolated wiping contacts [99,99a] which slide upon the curved contact strips [100,100a], which are also electrically isolated. D.C. electricity is supplied by battery [101], which is connected as illustrated to the contact strips. The wiping contacts and the contact strips are made of electrically conductive material. Wiping contact [99] slides on strips [100], and wiping contact [99a] slides on strips [100a]. The strips are electrically conductive but isolated from each other in the vertical vehicle position [V]. The wiping contacts, when tilted one way by vehicle tilt action, electrically connect the two outer contact strips together, and the two inner contact strips together, creating a flow of electricity to the variable force steer transmitter. In the other direction of tilt a mirrored operation occurs except that the electrical polarity is reversed to the variable force steer transmitter. An electronic control unit [ECU] [21] controls the voltage available to the variable force steer transmitter according to vehicle speed. This is purely a fundamental illustration, and refinements can be applied which are well known in the art. Other types of switches can be used which direct mechanical, electrical, pneumatic or hydraulic power sources.

In FIG. [11b] the coupling of the switch [94] to the lower cross arm [13] is made by a pivotally connected rod [97], connecting the lever arm [98] attached to the switch shaft [axis 96] to the lower cross arm [13], and so the switch can respond to vehicle tilt action and becomes a register of variations in the vehicle tilt position. Also in FIG. [11, 11a, 11b] is shown a variable force steer transmitter [16] [in this example a DC electric motor], attached to the upper cross arm [B] of a vehicle with 2 front wheels [42,42a]. A winch drum [83], attached to the output shaft of the motor, drives a cord [84] which is wound and locked to the drum and then connects to steering arms [1,1a], so that rotation of the motor clockwise, FIG. [11], resiliently urges the wheels right, and rotation of the motor anti clockwise resiliently urges the wheels left. Springs [85] are shown fitted in the cord [84] to maintain tension in the cord during any slight variations in the fitted length of the cord as the vehicle tilts and steers. The rotation direction is controlled by the switch [94] according to vehicle tilt position, and the amplitude of the voltage [and so the urging] is controlled by a vehicle speed sensitive control signal transmitter, for example, an electronic control unit which varies the voltage supplied to the variable force steer transmitter according to vehicle speed, as previously described. Other types of variable force power transmitters can be used based on hydraulic, pneumatic, electrical or mechanical operation.

The switching may be designed as a resilient position control servo mechanism where the variable force steer transmitter resiliently urges the wheel/s into resilient steer angle positions depending fundamentally on vehicle tilt angle and vehicle speed, but with additional computer generated inputs as desired. In this way a form of “steer by wire” can interact with the naturally occurring dynamic steer position control of the castoring wheel/s.

A desirable characteristic of the vehicle is the feedback to the driver via the control, due to the sensor reaction spring recording the vehicles natural tendency to always return to vertical. Observations indicate that this characteristic fundamentally derives from the fact that the front wheel/wheels run naturally at a steer angle which produces this “counter tilt force” This tilt force is a vehicle countersteer tilt force, and vehicle countersteer can be defined as “any steer angle that produces a tilt force”. Important consequences follow because when the vehicle is being forced to tilt into the corner, [the vehicle countersteer tilt force being balanced by the driver input/hydraulic assist tilt force], the weight on the outer wheels increases relative to the weight on the inner wheels. The vehicle is now gaining stability from its width of track, as well as its inclination. This allows the vehicle to corner at less tilt angle for any given speed and radius of corner. The vehicle is “under tilting”. The flow on effect is that the driver experiences a lateral loading which assists the judgement of his steer inputs. The term “load shedding” is used to describe this condition. The amount of load shedding can be easily varied throughout the vehicles full speed range by arranging the low speed variable force steer transmitter to operate outside its normal range under control of the ECU, and so various rates of tilt steer and load shedding can be applied to the vehicle as desired over the full range of vehicle speed. If, at higher speeds, no torque is applied to the wheel/wheels steer axis/axes by the variable force steer transmitter then most drivers will not be conscious of the effect, except in the way that it is represented in the self centering of the control. However if the “castoring element” is resiliently urged to steer more in the direction of the vehicle tilt by the variable force steer transmitter then the loading of the vehicle to return to vertical increases [as does the load shedding], and the steered vehicle path will be a tighter curved path relative to the vehicle tilt angle, and so the driver input angle on the control will be less to produce a given steered path radius at a given speed. And so the driver becomes more aware of the approaching vehicle limits and is better able to identify these limits, as is commonly learned in a conventional motorcar. The running steer angle position of the castoring element determines: 1] the loading on the vehicle to return to vertical, 2] The loading of the control to return to centre, 3] the loading of the outer wheels relative to the inner wheels, 4] the lateral loading on the driver and 5] The steered path radius relative to the driver input on the control. Those skilled in the art will be able to create the optimal vehicle “feel”.

A vehicle of this invention using a castoring element comprising of two wheels requires a suspension that allows correct functioning of the vehicle systems. In fact the systems described in FIGS. [7, 7a, 7b] and FIG. [9], cannot be correctly performed without the suspension system now to be described.

I will now describe the best way known to me to perform the suspension on a vehicle with two front wheels. Please refer to FIG. [12] [12a]. [Note: the wheel steer pivot suspension structures are shown on full right lock in FIG. [12a]. The upper and lower cross arms of the parallelogram [8], and [13]], are one piece items rotating on their centres [26], and [26a], on axles located on the tiltable vehicle section, or in this case shown located on the cross arms. Each cross arm has ball joints [40], fitted to their ends which attach in turn to the closed fork wheel steer pivot suspension structures [2,2a], which allows the parallelogram to tilt, and the steer pivot suspension structures to turn in steering, and the steer pivot suspension structures to also tilt with the tiltable section of the vehicle. The wheel stub axles [39,39a] are fitted to axle carriers [52,52a] which are located by and slide on the parallel bars [41] formed within the steer pivot suspension structures. The lever arms [1,1a] that connect the two wheels in alignment via track rod [not shown], are mounted on the steer pivot suspension structures, and so are the lever arms that are used during low speed control [19,19a]. When the wheels move in suspension by the sliding of the carriers on the parallel bars, the steer levers and track rod do not move. This arrangement prevents any form of bump steer occurring at any vehicle tilt angle, and the arrangement also causes the vehicle wheels to move in substantially the same plane as their inclination when the wheels move in suspension at any angle of vehicle tilt. This ensures that the wheels behave in a similar manner to the wheel on a motorcycle, and the vehicle tyres follow the natural rolling path at all times over bumps and hollows in the road surface. The tilt action and the suspension action are totally distinct. The suspension element [53], can be located as desired between the wheel carriers [52,52a], and the steer pivot structures [2,2a], as shown, or by other arrangement. In the arrangement illustrated one end of a metal spring [53] sits on a support pad [81] located on the carrier [52,52a], and the other end of the spring sits on a support pad [81] located on the steer pivot structure [2,2a], providing sprung support for the vehicle.

The various elements that I have described are all fundamentally important to the performance of my invention. The invention has been described in its preferred forms to the best of my knowledge at this time, but the descriptions are made only by way of example and numerous changes in the details of construction and the combination and arrangement of parts may be resorted to, without departing from the spirit and scope of the invention. It is intended that the patent shall cover by suitable expression in the appended claims whatever features of patentability exist in the invention described.

1. A tilting vehicle, comprising:
at least one section of the vehicle tiltable about the longitudinal axis of the vehicle;
tilt registration means, recording variations in the tilt position of the tiltable section of the vehicle;
a control element, for the driver;
tilt control means, connecting the control element to the tilting action of the tiltable section of the vehicle;
at least three wheels, including wheels laterally spaced, at least one front wheel, and at least one rear wheel;
a castoring element, including at least one front wheel which is able to tilt with the tiltable section of the vehicle and is dynamically directionally controllable due to the tilt of the tiltable section of the vehicle and the speed of the vehicle;
a vehicle speed sensitive control signal transmitter;
a variable force steer transmitter, which is connected to the castoring element, to the tilt registration means, and to the speed sensitive control signal transmitter, the said variable force steer transmitter being able to exert a directing moment and/or positioning moments on the castoring element, that directs and/or positions the castoring element according to the tilt registration and the force exerted by the variable force steer transmitter, and the force exerted by the variable force steer transmitter is variable according to control signals from the vehicle speed sensitive control signal transmitter.

2. A tilting vehicle as in claim 1 wherein the tilting control means further includes at least one sensor, for measuring the magnitude and/or the direction of the load resisting a change to the tilt angle of the tiltable section of the vehicle, and for measuring the magnitude and/or the direction of the load tending to create a change in the tilt angle of the tiltable section of the vehicle, connected to at least one power assist tilt drive element, for tilting the tiltable section of the vehicle about the longitudinal axis of the vehicle in order to produce a tilt according to the measurements made by the at least one sensor.

3. A tilting vehicle as in claim 2 wherein two sensors are independently sensing, and two power assist tilt drive elements are independently driving, and wherein one sensor is connected to one power assist tilt drive element and the other sensor is connected to the other power assist tilt drive element.

4. A tilting vehicle as in claim 3, wherein a sensor incorporates a twistable element which connects the control element and the tilting action of the tiltable section of the vehicle to one another, the degree and the direction of the twist of which element is a measure for the magnitude and the direction of the load resisting a change to the tilt angle of the tiltable section of the vehicle and the load tending to create a change in the tilt angle of the tiltable section of the vehicle.

5. A tilting vehicle as in claim 3 wherein a power assist tilt drive element is a double acting hydraulic cylinder/piston assembly or two single acting, hydraulic cylinder/piston assemblies, and a sensor is a hydraulic rotary spool valve connected to a hydraulic pump.

6. A tilting vehicle as in claim 1 wherein a castoring element includes two front wheels supported in steer pivot suspension structures, which are pivotally attached to tilting linkage structure, which is rotatably attached to the tiltable section of the vehicle, to enable interdependent side to side tilting of the tiltable section of the vehicle and the steer pivot suspension structures relative to the ground, and also to enable side to side steering movement of the steer pivot suspension structures, and with steer transmitting structure connecting each steer pivot suspension structure to the variable force steer transmitter.

7. A tilting vehicle as in claim 6, wherein each front wheel is fitted to an axle to allow rotation of the wheel when the vehicle is under way, and each axle is attached to a carrier which is located by and slides on a parallel bar guide when the wheel moves in suspension, and the parallel bar guide is formed within a steer pivot suspension structure, and the parallel bar guide is aligned with the parallel bars substantially in the same plane as the wheel, and with the parallel bars substantially parallel to the steer pivot suspension structure pivot axis, and a suspension element is fitted between the carrier and the wheel pivot suspension structure, and a steer lever arm is attached to the steer pivot suspension structure to allow a steering moment to be applied.

8. A tilting vehicle as in claim 1 wherein the tilt registration means is a switching element connected to the tilting action of the vehicle.

9. A tilting vehicle as in claim 1 wherein a vehicle speed sensitive control signal transmitter is an electronic control unit.

10. A tilting vehicle as in claim 1 wherein the variable force steer transmitter includes a variable coupling with the output torque of the coupling proportional to an electric control signal.

11. A tilting vehicle as in claim 1 wherein the variable force steer transmitter includes a resilient element connected to the castoring element.

12. A tilting vehicle as in claim 1, wherein the control element comprises a steering wheel or steering bar rotatable about a steering column.
